(19) United States
(12) Patent Application Publication
(10) Pub. No.: US 2013/0099622 A1
(43) Pub. Date: Apr. 25, 2013

(54) STATOR CORE AND SPINDLE MOTOR INCLUDING THE SAME

(71) Applicants: Song Bon OH, Suwon (KR); Jong Ryeol Oh, Seoul (KR)

(72) Inventors: Song Bon OH, Suwon (KR); Jong Ryeol Oh, Seoul (KR)

(73) Assignee: SAMSUNG ELECTRO-MECHANICS CO., LTD., Suwon (KR)

(21) Appl. No.: 13/442,378

(22) Filed: Apr. 9, 2012

(30) Foreign Application Priority Data
Oct. 24, 2011 (KR) 10-2011-0108441

(51) Int. Cl. H02K 1/14

(52) U.S. Cl. 310/216.106

(57) ABSTRACT

There is provided a stator core including: a coreback having an installation hole formed therein; a plurality of teeth extended from the coreback in a radial direction; and extension parts, each extended from each of the plurality of teeth in a circumferential direction and having a through-hole formed therein to reduce cogging torque.

### CROSS-REFERENCE TO RELATED APPLICATIONS

This application claims the priority of Korean Patent Application No. 10-2011-0108441 filed on Oct. 24, 2011 in the Korean Intellectual Property Office, the disclosure of which is incorporated herein by reference.

### BACKGROUND OF THE INVENTION

1. Field of the Invention

The present invention relates to a stator core and a spindle motor including the same, and more particularly, to a stator core having a coil wound therearound and a spindle motor including the same.

2. Description of the Related Art

Generally, a small sized spindle motor used in a hard disk drive (HDD) may be configured of a rotor and a stator.

Meanwhile, the rotor, a rotating member rotating while being supported by the stator, may include a rotor hub having a magnet installed thereon.

In addition, the stator may include a stator core disposed to face the magnet, and is a fixed member for rotatably supporting the rotor.

Further, the stator core included in the stator includes a core wound therearound, wherein the coil has power supplied from the outside applied thereto.

Further, the rotor hub may rotate through electromagnetic interaction between the magnet and the stator core around which the coil is wound. That is, when power is supplied to the coil, the rotor hub rotates through electromagnetic interaction between the stator core and the magnet.

In addition, as shown in FIG. 1, the stator core 10 may include a ring shaped coreback 12, teeth 14 extended from the coreback 12, and extension parts 16 formed at distal end portions of the teeth 14 and extended in a circumferential direction so as to increase an area facing the magnet 20.

Meanwhile, the extension parts 16 of the stator core 10 are disposed to be spaced apart from each other by predetermined intervals, such that open areas “a” are formed between the extension parts 16.

However, when the magnet 20, installed on the rotor hub, rotates together therewith, a magnitude of magnetic flux distribution changes due to the extension parts 16 and the open areas “a” formed between the extension parts 16, and cogging torque is generated by a change amount of magnetic flux.

Therefore, vibrations and noise are generated at the time of the rotation of the rotor hub.

Meanwhile, in order to reduce the cogging torque causing these vibrations and noise, a technology of forming grooves 16a in front ends of the extension parts 16, as shown in FIG. 2, has been developed. However, in this case, intervals “g” between the front ends of the extension parts 16 and an inner surface of the magnet 20 are not constant, such that irregular air flow may occur at the time of the rotation of the rotor hub.

Therefore, noise such as a whistling sound, or the like, may additionally be generated.

### SUMMARY OF THE INVENTION

An aspect of the present invention provides a stator core capable of reducing cogging torque, and a spindle motor including the same.

According to an aspect of the present invention, there is provided a stator core including: a coreback having an installation hole formed therein; a plurality of teeth extended from the coreback in a radial direction; and extension parts, each extended from each of the plurality of teeth in a circumferential direction and having a through-hole formed therein to reduce cogging torque.

The through-hole may be formed from an upper surface of the extension part toward a lower surface thereof in order to reduce the cogging torque.

The through-hole may have a circular cross section, and a diameter of the through-hole and an interval between the extension parts may have a ratio of 0.5 to 1:1 therebetween.

According to another aspect of the present invention, there is provided a spindle motor including: a rotor part including a rotor hub having a magnet mounted on an inner surface thereof; and a stator part rotatably supporting the rotor part and including a stator core disposed to face the magnet, wherein the stator core includes: a coreback having an installation hole formed therein; a plurality of teeth extended from the coreback in a radial direction; and extension parts, each extended from each of the plurality of teeth in a circumferential direction and having a through-hole formed therein to reduce cogging torque.

The stator part may further include: a base member including a sleeve housing having the stator core installed thereon; and a sleeve fixedly inserted into the sleeve housing, wherein the stator core may be fixedly installed on an outer peripheral surface of the sleeve housing so that a front end of the extension part is disposed to face the magnet.

The rotor part may further include a shaft rotatably installed in the sleeve and having the rotor hub mounted on an upper end portion thereof to thereby rotate together with the rotor hub, and the through-hole may be formed in parallel with the shaft.

The through-hole may be disposed on an extension line extended from the teeth and may be formed inside the extension part.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 and 2 are plan views showing a stator core according to the related art;

FIG. 3 is a schematic cross-sectional view showing a spindle motor according to an embodiment of the present invention;

FIG. 4 is a perspective view showing a stator core according to the embodiment of the present invention;

FIG. 5 is a plan view showing the stator core and a magnet according to the embodiment of the present invention;

FIG. 6 is a graph comparing cogging torque of the stator core according to the embodiment of the present invention with cogging torque of the stator core according to the related art;

FIG. 7 is a graph comparing a torque constant of the stator core according to the embodiment of the present invention with a torque constant of the stator core according to the related art;

FIG. 8 is a graph describing a change in cogging torque according to a ratio between a diameter of a through-hole formed in the stator core and an interval between extension parts of the stator core according to the embodiment of the present invention; and

FIG. 9 is a cross-sectional view schematically showing a spindle motor according to another embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

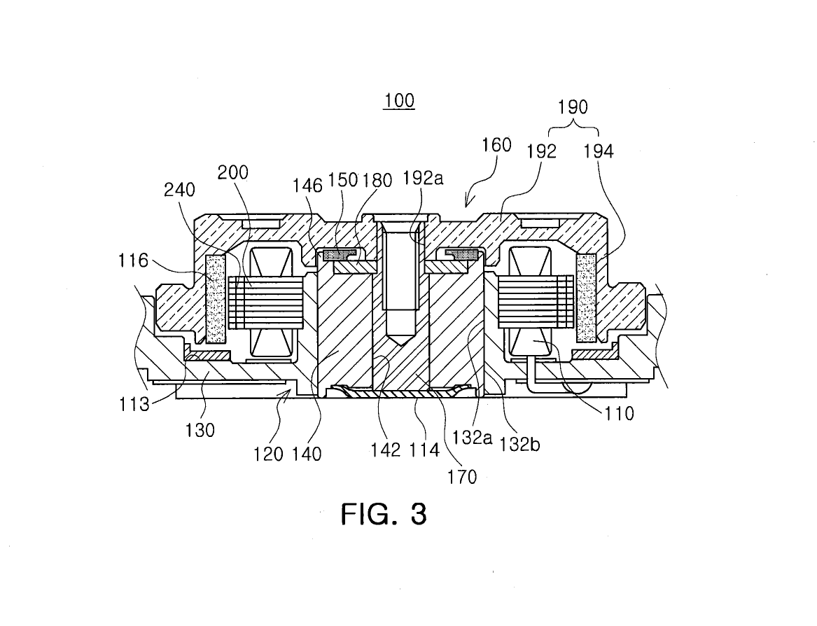

FIG. 3 is a schematic cross-sectional view showing a spindle motor according to an embodiment of the present invention.

Referring to FIG. 3, the spindle motor 100 according to the embodiment of the present invention may include a stator part 120 and a rotor part 160 by way of example.

The stator part 120 may rotatably support the rotor part 160. The stator part 120 may include a base member 130, a sleeve 140, a cap member 150, and a stator core 200.

First, the base member 130 may include a sleeve housing 132 having the sleeve 140 insertedly installed therein. In addition, the sleeve housing 132 may include an installing hole 132a formed so that the sleeve 140 may be insertedly installed therein.

That is, the sleeve 140 may be fixedly inserted into the sleeve housing 132.

Meanwhile, the sleeve housing 132 may include a step part 132b provided on an outer peripheral surface thereof so that the stator core 200 may be fixedly inserted thereinto. That is, the stator core 200 may be fixedly installed on the sleeve housing 132 in a state in which it is seated on the step part 132b formed on the outer peripheral surface of the sleeve housing 132.

Further, the base member 130 may include a magnetic pulling plate 113 installed thereon to thereby suppress excessive floating of the rotor part 160.

The sleeve 140 may be fixedly inserted into the sleeve housing 132 as described above. In addition, the sleeve 140 may have a through-hole 142 formed at the center thereof to thereby rotatably support a shaft 170.

Meanwhile, the sleeve 140 may include a cover member 114 installed on a lower surface thereof in order to prevent leakage of a lubricating fluid.

In addition, the sleeve 140 may include an outer wall part 146 provided at an upper end portion thereof so that the cap member 150 may be mounted on or attached thereto. The cap member 150 may be fixedly installed on the sleeve 140 so that an outer peripheral surface thereof contacts an inner peripheral surface of the outer wall part 146.

Meanwhile, the cap member 150 may serve to form an interface between the lubricating fluid and air together with the rotor part 160. The detailed description thereof will be provided below.

The rotor part 160 may include a rotor hub 190 having a magnet 116 mounted on an inner surface thereof. Meanwhile, the rotor part 160 may include the shaft 170, a thrust plate 180, and the rotor hub 190.

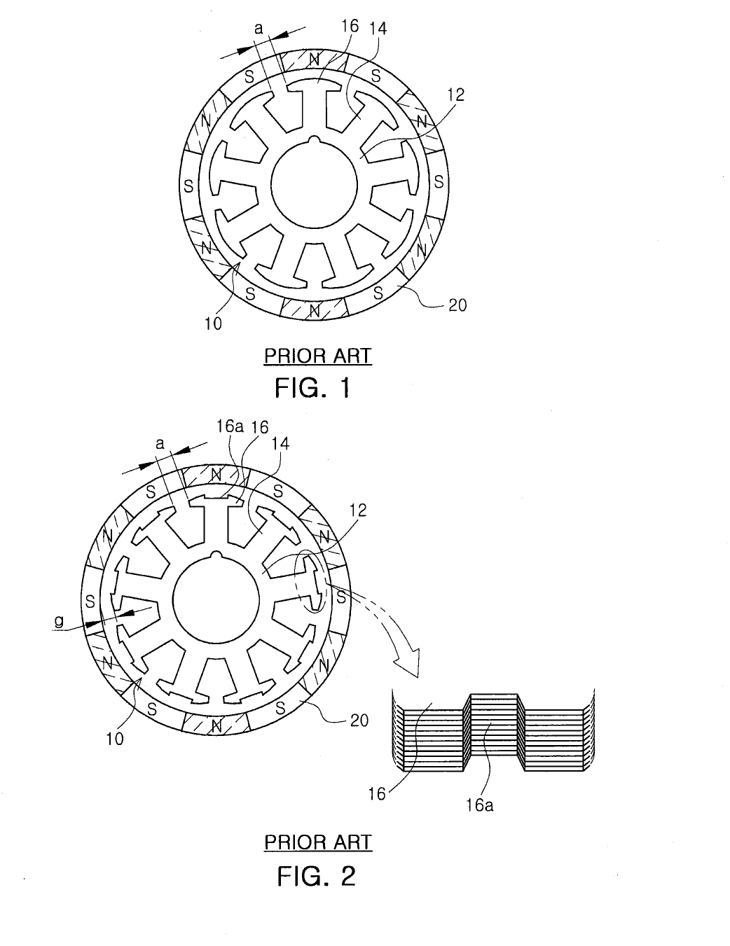

Here, terms with respect to directions will be defined. As viewed in FIG. 1, an axial direction refers to a vertical direction, that is, a direction from an upper portion of the shaft 170 toward a lower portion thereof or a direction from the lower portion of the shaft 170 toward the upper portion thereof. In addition, a radial direction refers to a direction from an outer peripheral surface of the rotor hub 190 toward the shaft 170, and a circumferential direction refers to a rotation direction along the outer peripheral surface of the rotor hub 190.

First, the shaft 170 may be rotatably installed in the sleeve 140. That is, the shaft 170 may be insertedly installed in the through-hole 142 of the sleeve 140. Here, an outer peripheral surface of the shaft 170 and an inner peripheral surface of the sleeve 140 may be disposed to be spaced apart from each other by a predetermined interval to thereby form a bearing clearance.

In addition, this bearing clearance may be filled with the lubricating fluid so as to generate fluid dynamic pressure at the time of rotation of the shaft 170.

Meanwhile, a dynamic pressure groove (not shown) pumping the lubricating fluid at the time of the rotation of the shaft 170 to thereby generate fluid dynamic pressure may be formed in at least one of the outer peripheral surface of the shaft 170 and the inner peripheral surface of the sleeve 140.

That is, the fluid dynamic pressure supporting the shaft 170 may be generated by the dynamic pressure groove at the time of the rotation of the shaft 170, whereby the shaft 170 may more stably rotate.

A bearing clearance may also be formed by the sleeve 140 and the cover member 114, wherein the bearing clearance formed by the sleeve 140 and the cover member 114 may be also filled with the lubricating fluid.

In addition, in the case in which the shaft 170 is installed in the sleeve 140, a lower surface of the shaft 170 may contact an upper surface of the cover member 114. Subsequently, in the case in which the shaft 170 rotates, the lubricating fluid flows between the sleeve 140 and the cover member 114 to thereby float the shaft 170 to a predetermined height.

The thrust plate 180 may be fixedly installed on the shaft 170 and rotate together with the shaft 170 at the time of the rotation of the shaft 170. Further, the thrust plate 180 may be installed to face an upper surface of the sleeve 140.

Meanwhile, a bearing clearance may also be formed by a lower surface of the thrust plate 180 and an upper surface of the sleeve 140, wherein the bearing clearance may be also filled with the lubricating fluid. In addition, a thrust dynamic groove (not shown) for generating dynamic pressure through the filled lubricating fluid may be formed in at least one of the lower surface of the thrust member 180 and the upper surface of the sleeve 140.

That is, in the case in which the thrust plate 180 rotates together with the shaft 170, thrust fluid dynamic pressure directed upwardly in the axial direction may be generated by the above-mentioned thrust dynamic groove.

Therefore, the shaft 170 may be more easily floated.

Meanwhile, an interface between the lubricating fluid and the air may be formed by a lower surface of the cap member 150 and an upper surface of the thrust plate 180. To this end, the cap member 150 may have an inclined surface formed at a distal end portion of the lower surface thereof.

That is, an interface between the lubricating fluid filled in the above-mentioned bearing clearance and the air may be formed in a sealing part formed by the lower surface of the cap member 150 and the upper surface of the thrust plate 180 by a capillary phenomenon.

The rotor hub 190 may be fixedly coupled to an upper end portion of the shaft 170 to thereby rotate together with the shaft 170.

In addition, the rotor hub 190 may include a disk shaped body 192 having an mounting hole 192a formed therein, the mounting hole 192a having the shaft 170 penetrating therethrough, and a magnet installing part 194 extended downwardly from an edge of the body 192 in an axial direction.

Further, the magnet installing part 194 may include the magnet 116 installed on an inner peripheral surface thereof. That is, the magnet 116 may be fixedly installed on the inner peripheral surface of the magnet installing part 194 so as to be disposed to face a front end of the stator core 200.

In addition, the magnet 116 may have an annular ring shape and be a permanent magnet generating magnetic force having a predetermined strength by alternately magnetizing an N pole and an S pole in a circumferential direction. That is, the magnet 116 may serve to generate driving force for rotating the rotor hub 190.

In other words, when power is supplied to the coil 110 wound around the stator core 200, force capable of rotating the rotor hub 190 may be generated by electromagnetic interaction between the stator core 200 having the coil 110 wound therearound and the magnet 116. Therefore, the rotor hub 190 may rotate.

As a result, the shaft 170 and the thrust plate 180 installed onto the shaft 170 may also rotate together with the rotor hub 190 by the rotation of the rotor hub 190.

When the rotor hub 190 rotates as described above, the lubricating fluid filled in the bearing clearance may be pumped by the dynamic groove (not shown) and the thrust dynamic groove (not shown). Therefore, the fluid dynamic pressure is generated to thereby float the rotor part 160 to a predetermined height while supporting the rotation of the shaft 170.

As described above, the base member 110 may include the magnetic pulling plate 113 installed thereon, wherein the magnetic pulling plate 113 is disposed under the magnet 116 installed on the rotor hub 190 to thereby serve to prevent the rotor part 160 from being excessively floated.

Therefore, the rotor part 160 may rotate in a state in which it is floated at a predetermined height.

The stator core 200 may include a through-hole 240 formed therein and be fixedly installed on the outer peripheral surface of the sleeve housing 132. That is, the stator core 200 may be disposed to face the magnet 116 to thereby serve to generate driving force rotating the rotor hub 190 by electromagnetic interaction with the magnet 116.

A detailed description for the stator core 200 will be provided below with reference to the accompanying drawings.

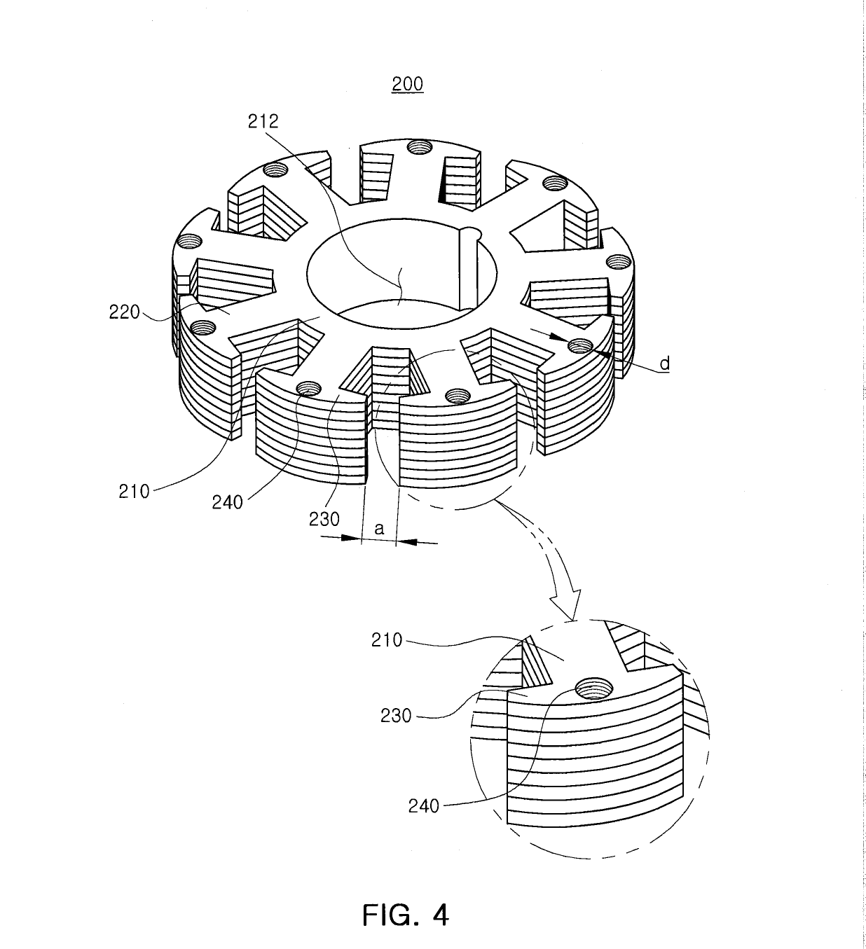

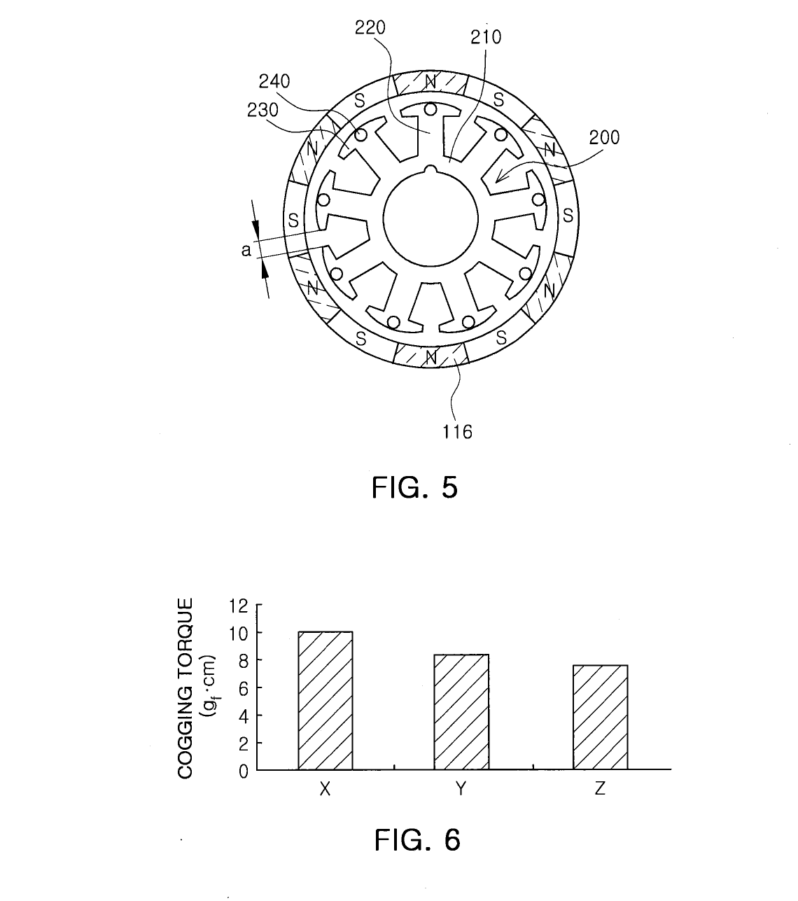

FIG. 4 is a perspective view showing a stator core according to the embodiment of the present invention; and FIG. 5 is a plan view showing the stator core and a magnet according to the embodiment of the present invention.

Referring to FIGS. 3 to 5, the stator core 200 according to the embodiment of the present invention may include a coreback 210, teeth 220, and extension parts 230.

The coreback 210 may have a ring shape in which it has an installation hole 212 formed therein so as to be fixedly inserted into the sleeve housing 132. That is, the coreback 210 may have a circular ring shape and be fixedly installed on an outer peripheral surface of the sleeve housing 132.

The teeth 230 may be formed to extend from the coreback 210 in a radial direction and be formed in plural. That is, the plurality of teeth 220 may be extended in the radial direction so as to be spaced apart from each other in a circumferential direction.

In addition, each of the extension parts 230 may be formed to extend from each of the plurality of teeth 220 and have a through-hole 240 formed therein in order to reduce cogging torque.

In addition, the extension part 230 may be disposed to be spaced apart from other extension parts 230 disposed adjacent thereto by predetermined intervals. In other words, each of the extension parts 230 may also be extended from each of the plurality of teeth 220 so as to be spaced apart from each other by a predetermined interval.

That is, each of the extension parts 230 extended from each of the plurality of teeth 220 may also be disposed to be spaced apart from each other by a predetermined interval (a) in the circumferential direction.

Meanwhile, the magnet 116 disposed to face front ends of the extension parts 230 rotates together with the rotor hub 190 at the time of the rotation of the rotor hub 190. As described above, when the rotor hub 190 rotates, a magnitude and a direction of magnetic flux distribution of the magnet 116 with respect to the extension parts 230 change, such that cogging torque is generated by a change amount in a magnetic flux in the front ends of the plurality of extension parts 230 and spaces between the plurality of extension parts 230.

However, the stator core 200 according to the embodiment of the present invention includes the through-holes 240 formed in the extension parts 230 thereof, whereby the cogging torque may be reduced.

Meanwhile, the through-hole 240 may be formed from an upper surface of the extension part 230 toward a lower surface thereof in order to reduce the cogging torque. In other words, the through-hole 240 may be formed in the axial direction so as to be in parallel with the shaft 170.

As an example, the through-hole 240 may have a circular cross section, and a diameter (d) of the through-hole 240 and the interval (a) between the extension parts 230 may have a ratio of 0.5 to 1:1 therebetween.

The detailed description thereof will be provided below.

In addition, the through-holes 240 may be disposed on extension lines extended from the teeth 220 and be formed in the extension parts 230. That is, the through-holes 240 may be disposed inside the extension parts 230 to thereby allow gaps formed by an inner peripheral surface of the magnet 116 and the front ends of the extension parts 230 to be constant.

Therefore, noise caused by an irregular air flow generated at the time of the rotation of the rotor hub 190 may be reduced. That is, a whistling sound caused by the irregular air flow generated at the time of the rotation of the rotor hub 190 may be reduced.

Hereinafter, an effect of the stator core according to the embodiment of the present invention will be described with reference to the accompanying drawings.

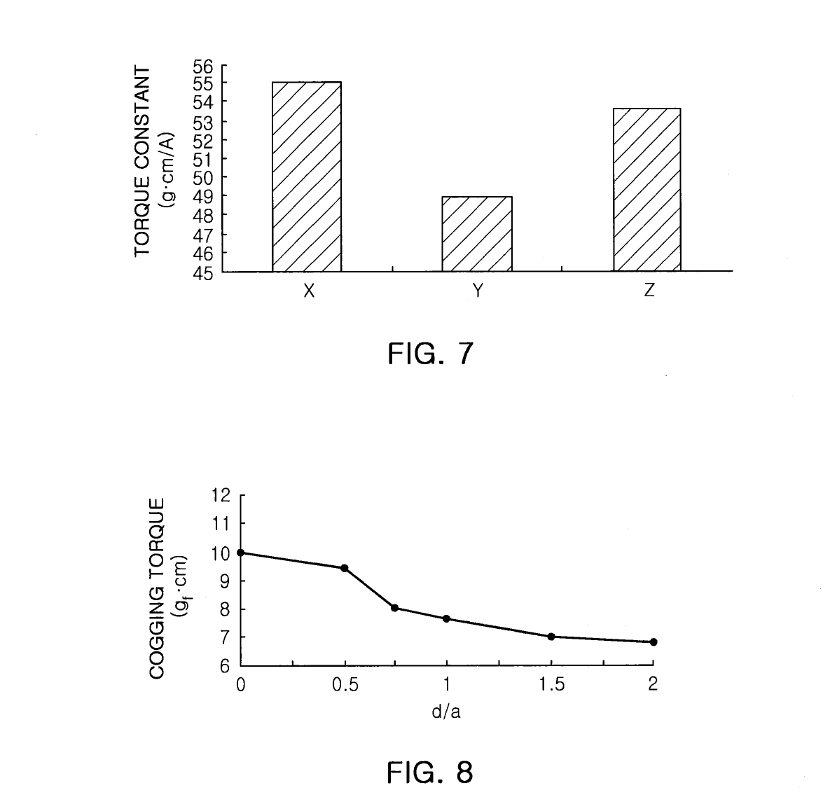

FIG. 6 is a graph comparing cogging torque of the stator core according to the embodiment of the present invention with cogging torque of the stator core according to the related art; FIG. 7 is a graph comparing a torque constant of the stator core according to the embodiment of the present invention with a torque constant of the stator core according to the related art; and FIG. 8 is a graph describing a change in cogging torque according to a ratio between a diameter of a through-hole formed in the stator core according to the embodiment of the present invention and an interval between extension parts of the stator core.

First, an effect of the stator core according to the embodiment of the present invention will be described with reference to FIG. 6.

Meanwhile, a vertical axis of FIG. 6 indicates a magnitude of cogging torque.

In addition, X of a horizontal axis indicates the stator core according to the related art, that is, the stator core (See FIG. 1) that does not have a configuration for reducing the cogging torque. Further, Y of the horizontal axis indicates the stator core according to the related art, that is, the stator core (See FIG. 2) having the groove formed in the front end part thereof in order to reduce the cogging torque. Further, Z of the horizontal axis indicates the stator core according to the embodiment of the present invention.

It could be appreciated from FIG. 6 that Z, the stator core according to the embodiment of the present invention, has cogging torque reduced as compared to X and Y which are the stator cores according to the related art.

Meanwhile, a vertical axis of FIG. 7 indicates a torque constant, that is, a torque constant indicating a magnitude of rotational driving force.

In addition, a horizontal axis of FIG. 7 indicates the same X, Y, and Z as those of the horizontal axis of FIG. 6.

It could be appreciated from FIG. 7 that Z, the stator core according to the embodiment of the present invention, has a torque constant larger than that of Y which is the stator core according to the related art. That is, it could be appreciated that Z may generate the larger rotational driving force.

In addition, it could be appreciated that Z, the stator core according to the embodiment of the present invention, has a torque constant lower than that of X which is the stator core according to the related art, but similar to that of X as compared to Y.

It could be appreciated from FIGS. 6 and 7 that Z, the stator core according to the embodiment of the present invention, may alleviate the reduction in magnitude of the rotational driving force while reducing the cogging torque.

In addition, referring to FIG. 8, a vertical axis indicates cogging torque, and a horizontal axis indicates a ratio between a diameter (d) of the through-hole and an interval (a) between the extension parts of the stator core.

It could be appreciated from FIG. 8 that the cogging torque is rapidly reduced in a range in which the ratio (d/a) between the diameter of the through-hole and the interval between the extension parts of the stator core is 0.5 to 1.

Further, it could be appreciated that the cogging torque is more significantly reduced at a portion in which the ratio (d/a) between the diameter of the through-hole and the interval between the extension parts of the stator core is 0.75.

Therefore, when the ratio (d/a) between the diameter of the through-hole and the interval between the extension parts of the stator core is 0.75, a reduction rate of the cogging torque may be significantly increased while the reduction in the torque constant (that is, the rotational driving force) is alleviated.

As described above, the through-hole 240 is formed in the extension part 230, whereby the cogging torque generated at the time of rotation of the magnet 116 may be reduced.

In addition, since the through-holes 240 are formed inside the extension parts 230, gaps formed by the inner peripheral surface of the magnet 116 and the front ends of the extension parts 230 are constant, whereby the noise generated due to the irregular air flow may be reduced.

Further, since the ratio (d/a) between the diameter of the through-hole 240 and the interval between the extension parts 230 is 0.5 to 1, the cogging torque may be further reduced.

Hereinafter, a spindle motor according to another embodiment of the present invention will be described with reference to the accompanying drawings.

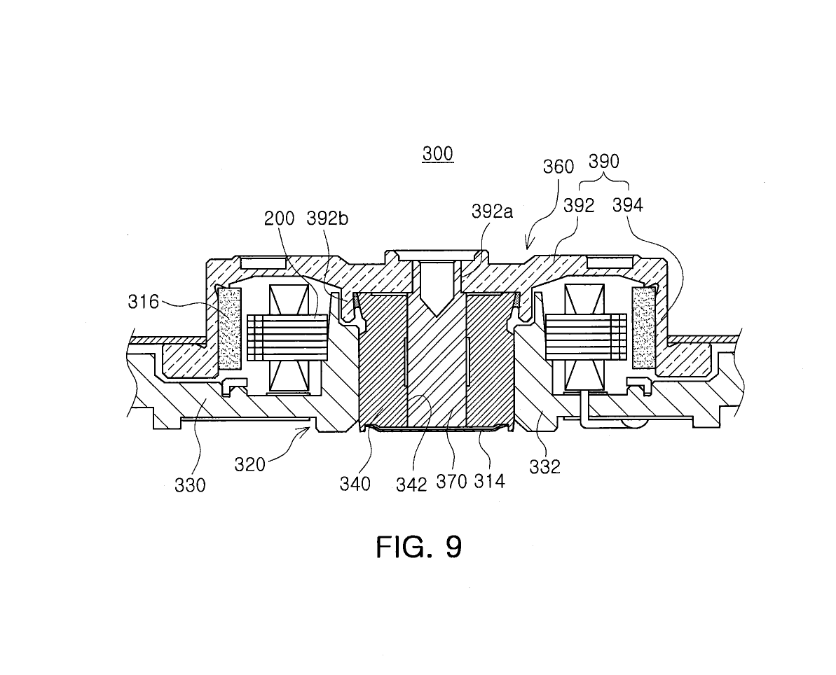

FIG. 9 is a cross-sectional view schematically showing a spindle motor according to another embodiment of the present invention.

Referring to FIG. 9, the spindle motor 300 according to another embodiment of the present invention may include a stator part 320 and a rotor part 360 by way of example.

The stator part 320 may rotatably support the rotor part 360. The stator part 320 may include a base member 330, a sleeve 340, and a stator core 200.

The rotor part 360 may include a rotor hub 390 having a magnet 316 mounted on an inner surface thereof. Meanwhile, the rotor part 360 may include a shaft 370 and the rotor hub 390.

Meanwhile, the base member 330, the stator core 200, and the shaft 370 according to another embodiment of the present invention are the same components as those according to the embodiment of the present invention described above. Therefore, a detailed description thereof will be omitted and be replaced with the above-mentioned description.

The sleeve 340 may be fixedly inserted into the sleeve housing 332. Further, the sleeve 340 may have a hollow cylindrical shape so that a through-hole 342 is formed at the center thereof.

Meanwhile, the sleeve 340 may include a cover member 314 installed on a lower surface thereof in order to prevent leakage of a lubricating fluid.

In addition, the rotor hub 390 may be coupled to an upper end portion of the shaft 370 to thereby rotate together with the shaft 370.

Further, a lower surface of the rotor hub 290 and an upper surface of the sleeve 340 are spaced apart from each other by a predetermined interval, such that the rotor hub 290 may be coupled to the shaft 370 so as to form a bearing clearance therebetween. This bearing clearance may be filled with a lubricating fluid.

A thrust dynamic groove (not shown) for generating thrust fluid dynamic pressure may be formed in at least one of a lower surface of the rotor hub 290 and an upper surface of the sleeve 340.

In addition, the rotor hub 390 may include a disk shaped body 392 having an mounting hole 392a formed therein, the mounting hole 392a having the shaft 370 penetrating therethrough, and a magnet installing part 394 extended downwardly from an edge of the body 392 in an axial direction.

Further, the magnet installing part 394 may include the magnet 316 installed on an inner peripheral surface thereof. That is, the magnet 316 may be fixedly installed on the inner peripheral surface of the magnet installing part 394 so as to be disposed to face a front end of the stator core 200.

In addition, the rotor hub 390 may include an extension wall part 392b extended so as to be disposed outside an outer peripheral surface of the sleeve 340 in a radial direction. That is, the extension wall part 392b serves to form an interface between the lubricating fluid and air together with the outer peripheral surface of the sleeve 340.

Other components included in the rotor hub 390 are the same as those included in the rotor hub 190 of the spindle motor 100 according to the embodiment of the present invention described above. Therefore, a detailed description thereof will be omitted.

The stator core 200 is also the same as the stator core 200 included in the spindle motor 100 according to the embodiment of the present invention described above. Therefore, a detailed description thereof will be omitted.

That is, the same effect as the effect implemented by the spindle motor 100 according to the embodiment of the present invention described above may also be implemented by the spindle motor 300 according to another embodiment of the present invention.

As set forth above, according to the embodiments of the present invention, the cogging torque may be reduced through the through-holes formed in the extension parts.

In addition, the through-holes may be formed in the extension parts, whereby the noise caused by the irregular air flow generated at the time of the rotation of the magnet may be reduced.

While the present invention has been shown and described in connection with the embodiments, it will be apparent to those skilled in the art that modifications and variations can be made without departing from the spirit and scope of the invention as defined by the appended claims.

What is claimed is:

1. A stator core comprising:
a coreback having an installation hole formed therein;
a plurality of teeth extended from the coreback in a radial direction; and
extension parts, each extended from each of the plurality of teeth in a circumferential direction and having a through-hole formed therein to reduce cogging torque.

2. The stator core of claim 1, wherein the through-hole is formed from an upper surface of the extension part toward a lower surface thereof in order to reduce the cogging torque.

3. The stator core of claim 1, wherein the through-hole has a circular cross section, and
a diameter of the through-hole and an interval between the extension parts have a ratio of 0.5 to 1:1 therebetween.

4. A spindle motor comprising:
a rotor part including a rotor hub having a magnet mounted on an inner surface thereof; and
a stator part rotatably supporting the rotor part and including a stator core disposed to face the magnet,
the stator core including:
a coreback having an installation hole formed therein;
a plurality of teeth extended from the coreback in a radial direction; and
extension parts, each extended from each of the plurality of teeth in a circumferential direction and having a through-hole formed therein to reduce cogging torque.

5. The spindle motor of claim 4, wherein the through-hole is formed from an upper surface of the extension part toward a lower surface thereof in order to reduce the cogging torque.

6. The spindle motor of claim 4, wherein the through-hole has a circular cross section, and
a diameter of the through-hole and an interval between adjacent extension parts disposed to be spaced apart from each other in the circumferential direction have a ratio of 0.5 to 1:1 therebetween.

7. The spindle motor of claim 4, wherein the stator part further includes:
a base member including a sleeve housing having the stator core installed thereon; and
a sleeve fixedly inserted into the sleeve housing, and
wherein the stator core is fixedly installed on an outer peripheral surface of the sleeve housing so that a front end of the extension part is disposed to face the magnet.

8. The spindle motor of claim 7, wherein the rotor part further includes a shaft rotatably installed in the sleeve and having the rotor hub mounted on an upper end portion thereof to thereby rotate together with the rotor hub, and
the through-hole is formed in parallel with the shaft.

9. The spindle motor of claim 4, wherein the through-hole is disposed on an extension line extended from the teeth and is formed inside the extension part.
